(19) United States
(12) Patent Application Publication
(10) Pub. No.: US 2012/0306828 A1
(43) Pub. Date: Dec. 6, 2012

(54) DRIVING CIRCUIT AND OPERATING METHOD THEREOF

(75) Inventors: Li-Ping Lin, Kaohsiung City (TW); Ko-Yang Tso, New Taipei City (TW); Chi-Yuan Lu, Zhongpu Township (TW); Chin-Chieh Chao, Hsinchu City (TW); Yu-Lung Lo, New Taipei City (TW)

(73) Assignee: Raydium Semiconductor Corporation, Hsinchu (TW)

(21) Appl. No.: 13/484,801

(22) Filed: May 31, 2012

(30) Foreign Application Priority Data
Jun. 3, 2011 (TW) 100119535

(51) Int. Cl. G09G 5/00; G09G 3/36

(52) U.S. Cl. 345/204; 345/87

(57) ABSTRACT

The invention provides a driving circuit applied in a LCD apparatus and operating method thereof. The driving circuit includes at least one first channel, at least one second channel, a timing controller, and a panel driver. The timing controller includes a digital signal switching unit. The digital signal switching unit selectively performs a polarity exchange to a first digital data signal and a second digital data signal according to a control signal. The panel driver includes an analog signal switching unit. The analog signal switching unit performs a switching corresponding to the polarity exchange according to the control signal to make the driving circuit selectively operated under a first operation mode or a second operation mode.

### BACKGROUND OF THE INVENTION

1. Field of the Invention

The invention relates to a liquid crystal display (LCD) apparatus, and particularly, to a driving circuit applied in the LCD apparatus.

2. Description of the Prior Art

In recent years, with the continuous progress of the image related technology, various new types of displays shown on the market have replaced conventional cathode ray tube (CRT) displays. Among these displays, the LCD apparatus has advantages of power saving and small size and is widely used by ordinary consumers; therefore, it has become the main stream of the display market.

In general, the driving circuit in the LCD display includes a timing controller (TCON), a source driver, and a gate driver. Wherein, the timing controller is a control IC used for generating and outputting a control timing to control the timings of a source driver and a gate driver of a LCD panel.

Please refer to FIG. 1 and FIG. 2A˜2B. FIG. 1 illustrates a functional block diagram of the timing controller and the source driver in the driving circuit of the conventional LCD apparatus; FIG. 2A˜2B illustrates a detailed functional block diagram of the source driver shown in FIG. 1. As shown in FIG. 1, the timing controller 10 in the conventional driving circuit 1 will transmit a digital data signal DATA to the source driver 12, and then transmit a polarity control signal POL and a video signal converting signal STB to the source driver 12. It should be noticed that there is no polarity conversion is performed on the digital data signal DATA transferred from the conventional timing controller 10 to the source driver 12; therefore, the source driver 12 will perform polarity conversion on the digital data signal DATA according to the polarity control signal POL.

As shown in FIG. 2A˜2B, the source driver 12 includes a first data latch unit 121, a second data latch unit 122, a first multiplex switching unit 123, a P-type digital-to-analog converting unit 124, a N-type digital-to-analog converting unit 125, a second multiplex switching unit 126, a first amplifying unit 127, and a second amplifying unit 128.

In FIG. 2A, the source driver 12 stores a first digital data signal DS1 and a second digital data signal DS2 in the first data latch unit 121 and the second data latch unit 122 respectively. Since the source driver 12 is operated under a first operation mode, the source driver 12 will determine that the first multiplex switching unit 123 performs no digital signal polarity conversion according to the received polarity control signal POL to output the first digital data signal DS1 and the second digital data signal DS2 to the P-type digital-to-analog converting unit 124 and the N-type digital-to-analog converting unit 125 respectively. Next, the P-type digital-to-analog converting unit 124 and the N-type digital-to-analog converting unit 125 perform digital-to-analog conversion on the first digital data signal DS1 and the second digital data signal DS2 respectively to convert them into a first analog data signal AS1 and a second analog data signal AS2, and then the first analog data signal AS1 and the second analog data signal AS2 are amplified by the first amplifying unit 127 and the second amplifying unit 128 and outputted to the LCD panel (not shown in the figures).

In FIG. 2B, the source driver 12 stores the first digital data signal DS1 and the second digital data signal DS2 in the first data latch unit 121 and the second data latch unit 122 respectively. Since the source driver 12 is operated under a second operation mode, the source driver 12 will determine that the first multiplex switching unit 123 performs digital signal polarity conversion on the first digital data signal DS1 and the second digital data signal DS2 according to the received polarity control signal POL to output the first digital data signal DS1 and the second digital data signal DS2 to the N-type digital-to-analog converting unit 125 and the P-type digital-to-analog converting unit 124 respectively. Next, the N-type digital-to-analog converting unit 125 and the P-type digital-to-analog converting unit 124 perform digital-to-analog conversion on the first digital data signal DS1 and the second digital data signal DS2 respectively to convert them into a first analog data signal AS1 and a second analog data signal AS2, and then the first analog data signal AS1 and the second analog data signal AS2 are amplified by the first amplifying unit 127 and the second amplifying unit 128 and outputted to the LCD panel (not shown in the figures).

From FIG. 2A˜2B, it can be known that in order to make the source driver 12 in the driving circuit 1 of the conventional LCD apparatus to finish the polarity conversion performed on the digital data signals D1, D2, . . . transmitted by every channels, an additional first multiplex switching unit 123 corresponding to every two channels must be disposed in the source driver 12. Therefore, with the increasing of channel number, a lot of multiplex switching units must be disposed in the source driver 12 to perform polarity conversion, not only the production cost of the source driver is increased, but also larger chip area is necessary to be used.

Therefore, the invention provides a source circuit applied in the LCD apparatus to solve the above-mentioned problems occurred in the prior arts.

### SUMMARY OF THE INVENTION

A scope of the invention is to provide a driving circuit applied in a LCD apparatus. In an embodiment, the driving circuit includes at least one first channel, at least one second channel, a timing controller, and a panel driver. The timing controller includes a digital signal switching unit. The digital signal switching unit selectively performs a polarity exchange to a first digital data signal and a second digital data signal according to a control signal. The panel driver includes an analog signal switching unit. The analog signal switching unit performs a switching corresponding to the polarity exchange according to the control signal to make the driving circuit selectively operated under a first operation mode or a second operation mode.

In practical applications, the panel driver can be a source driver of a panel. When the driving circuit is operated under the first operation mode, the digital signal switching unit inputs the first digital data signal to the first channel and inputs the second digital data signal to the second channel according to the control signal. The first digital-to-analog converting unit converts the first digital data signal into a first analog data signal, and the second digital-to-analog converting unit converts the second digital data signal into a second analog data signal. The analog signal switching unit receives the first analog data signal from the first digital-to-analog converting unit and receives the second analog data signal from the second digital-to-analog converting unit, the analog signal switching unit performs no switch according to the control signal and directly outputs the first analog data signal and the second analog data signal respectively.

When the driving circuit is operated under the second operation mode, the digital signal switching unit inputs the first digital data signal to the second channel and inputs the second digital data signal to the first channel according to the control signal. The first digital-to-analog converting unit converts the second digital data signal into a second analog data signal, and the second digital-to-analog converting unit converts the first digital data signal into a first analog data signal. The analog signal switching unit receives the second analog data signal from the first digital-to-analog converting unit and receives the first analog data signal from the second digital-to-analog converting unit, the analog signal switching unit switches the first analog data signal and the second analog data signal according to the control signal and then outputs the switched first analog data signal and second analog data signal.

Another scope of the invention is to provide a driving circuit operating method. In an embodiment, the driving circuit operating method is applied in a driving circuit of a LCD apparatus. The driving circuit includes at least one first channel, at least one second channel, a timing controller, and a panel driver. The timing controller includes a digital signal switching unit. The panel driver includes an analog signal switching unit. The digital signal switching unit selectively performs a polarity exchange to a first digital data signal and a second digital data signal according to a control signal. The analog signal switching unit performs a switching corresponding to the polarity exchange according to the control signal to make the driving circuit selectively operated under a first operation mode or a second operation mode.

Compared to the prior arts, the driving circuit and operating method thereof disclosed by this invention uses the digital signal switching unit in the timing controller to selectively perform polarity exchange between the digital data signals according to the polarity control signal (POL), and then inputs these digital data signal into the source driver. By doing so, the source driver performs no digital data signal polarity exchange as shown in FIG. 2A, therefore, the first multiplex switching units 123 disposed corresponding to every two channels are not necessary to effectively lower production cost and largely save the chip area used by the driving circuit to enhance the market competitiveness of the driving circuit and the LCD apparatus using the driving circuit disclosed by this invention.

The advantage and spirit of the invention may be understood by the following detailed descriptions together with the appended drawings.

### BRIEF DESCRIPTION OF THE DRAWINGS

FIG. 1 illustrates a functional block diagram of the timing controller and the source driver in the driving circuit of the conventional LCD apparatus.

FIG. 2A-2B illustrates a detailed functional block diagram of the source driver shown in FIG. 1.

FIG. 3 illustrates a functional block diagram of the driving circuit operated under a first operation mode in an embodiment of the invention.

FIG. 4 illustrates a functional block diagram of the driving circuit shown in FIG. 3 operated under a second operation mode.

FIG. 5 illustrates a flowchart of the driving circuit operating method in another embodiment of the invention.

FIG. 6 illustrates a flowchart of the driving circuit operating method when the driving circuit is operated under the first operation mode.

FIG. 7 illustrates a flowchart of the driving circuit operating method when the driving circuit is operated under the second operation mode.

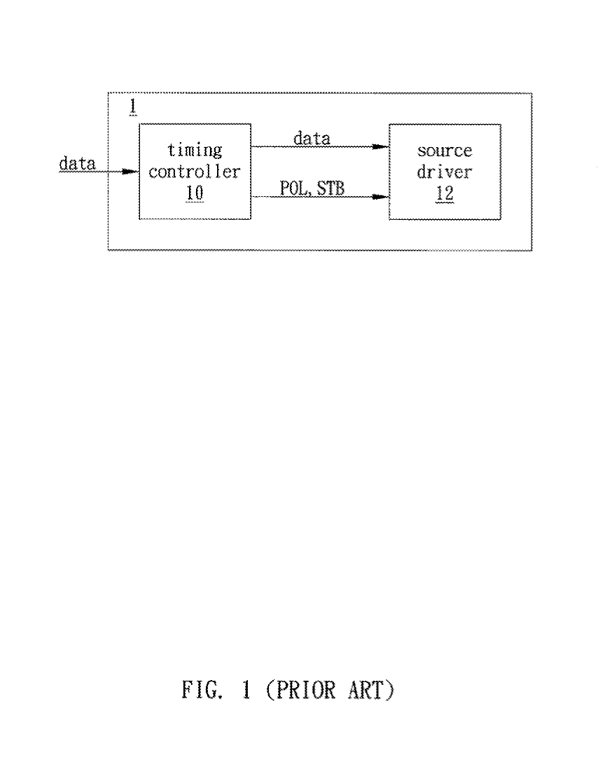

FIG. 1 illustrates a functional block diagram of the timing controller and the source driver in the driving circuit of the conventional LCD apparatus.

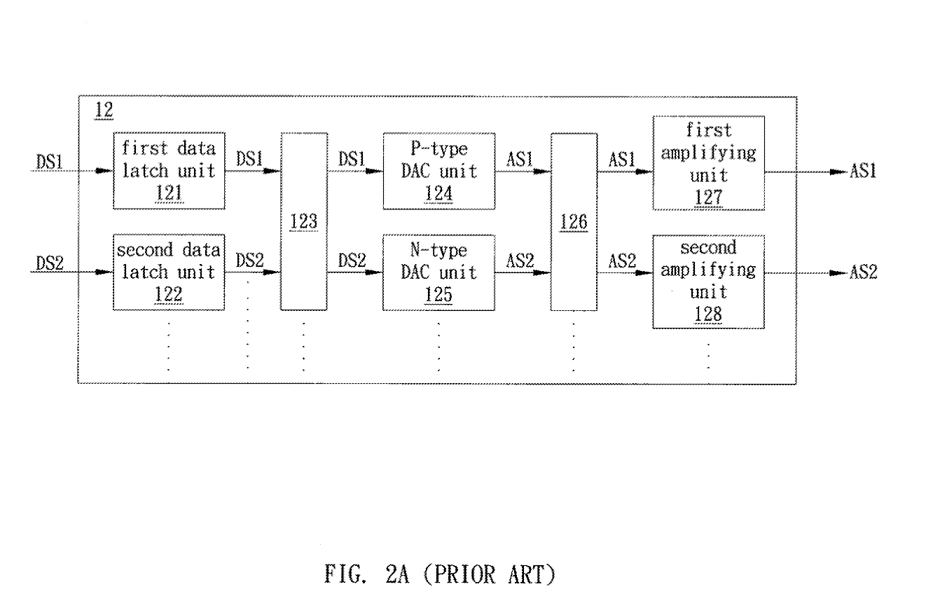

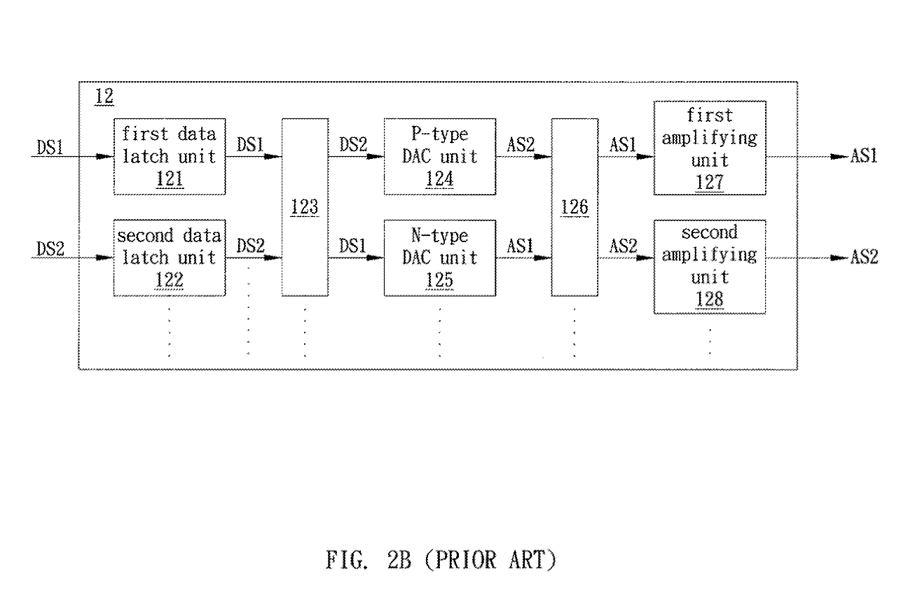

FIG. 2A-2B illustrates a detailed functional block diagram of the source driver shown in FIG. 1.

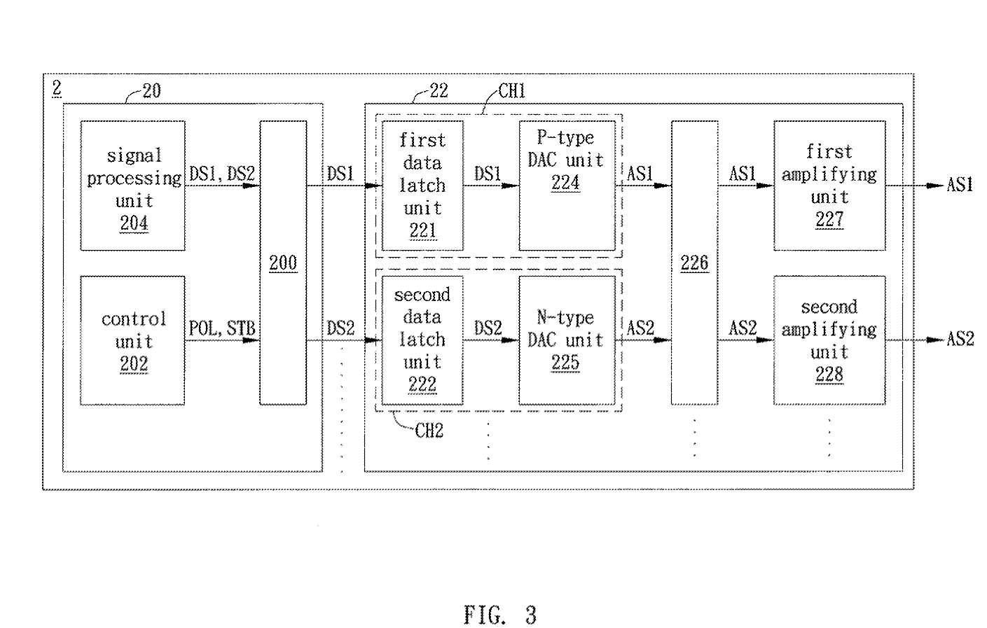

FIG. 3 illustrates a functional block diagram of the driving circuit operated under a first operation mode in an embodiment of the invention.

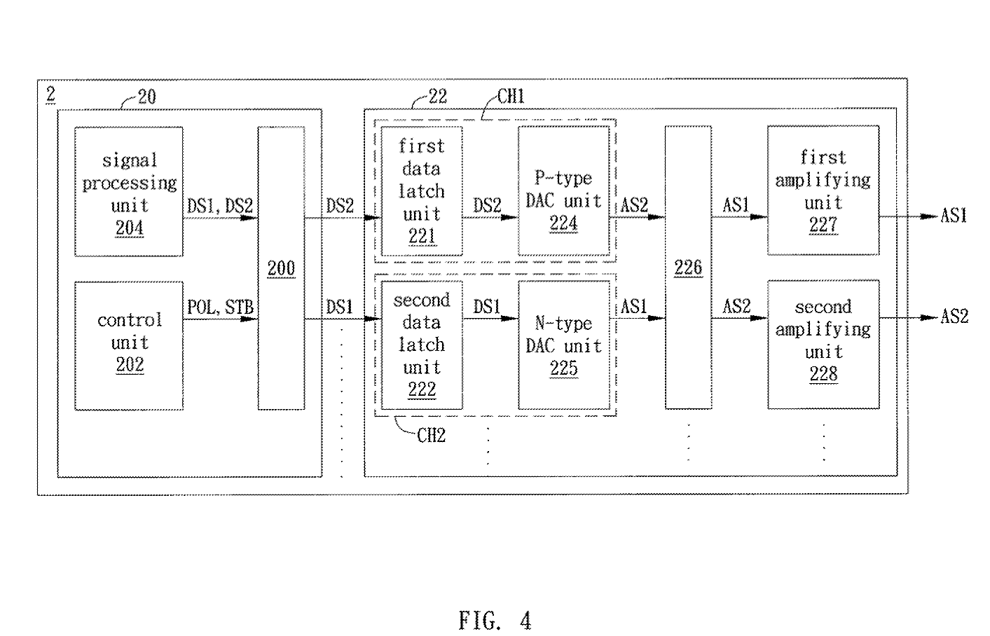

FIG. 4 illustrates a functional block diagram of the driving circuit shown in FIG. 3 operated under a second operation mode.

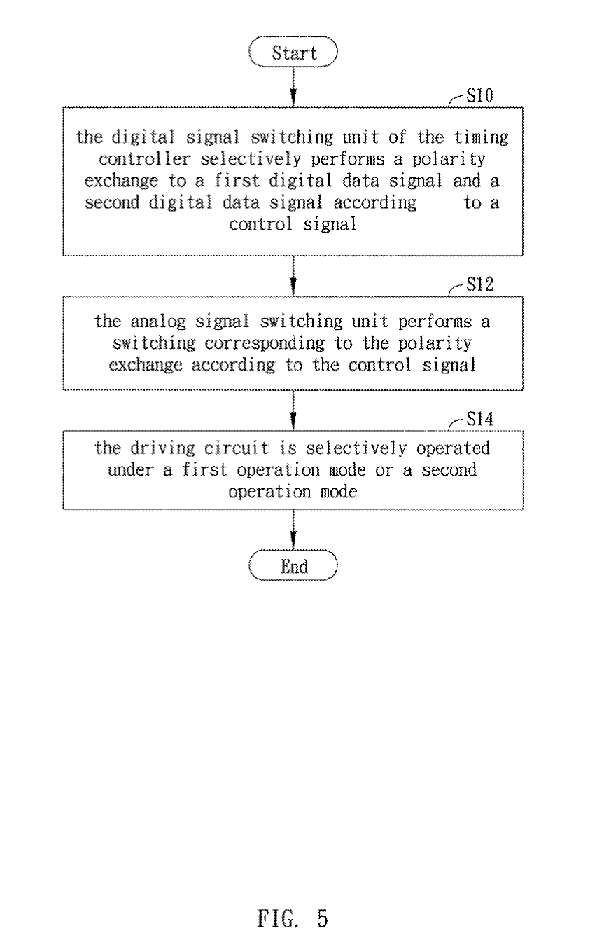

FIG. 5 illustrates a flowchart of the driving circuit operating method in another embodiment of the invention.

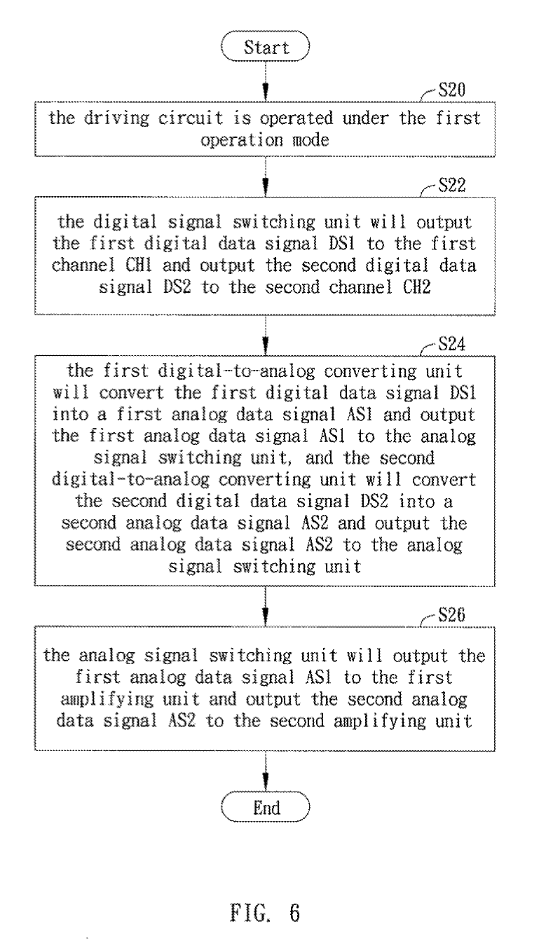

FIG. 6 illustrates a flowchart of the driving circuit operating method when the driving circuit is operated under the first operation mode.

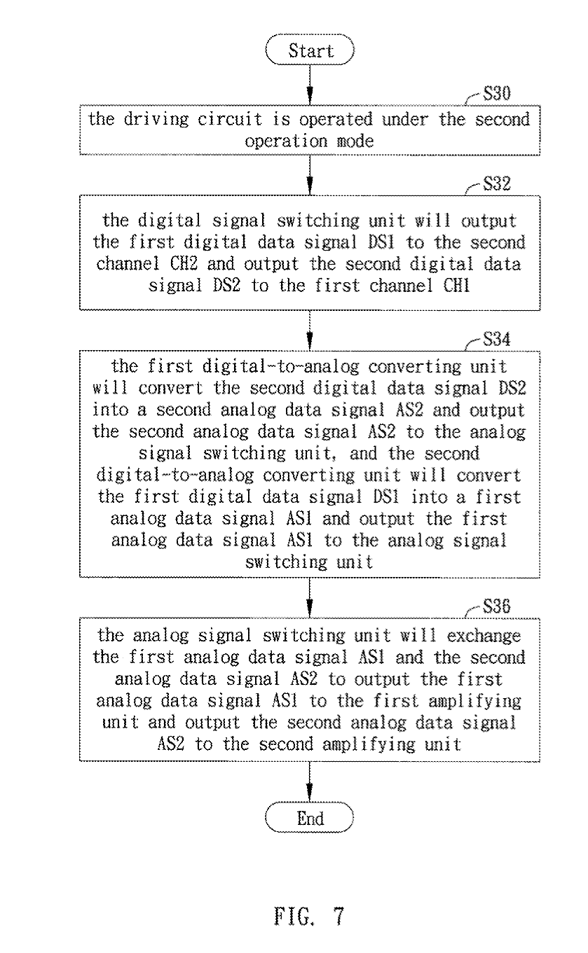

FIG. 7 illustrates a flowchart of the driving circuit operating method when the driving circuit is operated under the second operation mode.

### DETAILED DESCRIPTION

An embodiment of the invention is a driving circuit. In this embodiment, the driving circuit is applied in a LCD apparatus and used for driving a LCD panel, but not limited to this. The driving circuit includes at least one first channel, at least one second channel, a timing controller, and a panel driver. The timing controller includes a digital signal switching unit. The panel driver includes an analog signal switching unit. It should be noticed that the driving circuit of the invention has two operation modes. In detail, the driving circuit is selectively operated under a first operation mode or a second operation mode according to the corresponding polarity exchange between the digital signal switching unit of the timing controller and the analog signal switching unit of the panel driver. In fact, the panel driver can be a source driver of a panel, but not limited to this.

At first, please refer to FIG. 3. FIG. 3 illustrates a functional block diagram of the driving circuit operated under a first operation mode in this embodiment. As shown in FIG. 3, the driving circuit 2 includes a timing controller 20 and a source driver 22. The timing controller 20 includes a digital signal switching unit 200, a control unit 202, and a signal processing unit 204. The source driver 22 includes a first data latch unit 221, a second data latch unit 222, a P-type digital-to-analog converting unit 224, a N-type digital-to-analog converting unit 225, an analog signal switching unit 226, a first amplifying unit 227, and a second amplifying unit 228. Wherein, the first data latch unit 221 and the P-type digital-to-analog converting unit 224 belong to a first channel CH1; the second data latch unit 222 and the N-type digital-to-analog converting unit 225 belong to a second channel CH2.

It should be noticed that there are two channels CH1, CH2 and two digital data signals DS1, DS2 in this embodiment; however, the number of the channels and the digital data signals in driving circuit is not limited to this. In fact, the digital signal switching unit 200 and the analog signal switching unit 226 can be multiplexers; the first amplifying unit 227 and the second amplifying unit 228 can be ordinary amplifiers; the P-type digital-to-analog converting unit 224 can be a positive digital-to-analog converter (DAC); the N-type digital-to-analog converting unit 225 can be a negative digital-to-analog converter (DAC); the first data latch unit 221 and the second data latch unit 222 can be ordinary data latches, but not limited to this.

As shown in FIG. 3, when the driving circuit 2 is operated under the first operation mode, the signal processing unit 204 of the timing controller 20 will transmit the first digital data signal DS1 and the second digital data signal DS2 to the digital signal switching unit 200, and the control unit 202 will also transmit a polarity control signal POL and a digital video signal converting signal STB to the digital signal switching unit 200. When the digital signal switching unit 200 receives the polarity control signal POL, the digital signal switching unit 200 will find out that the driving circuit 2 is operated under the first operation mode according to the polarity control signal POL, therefore, the digital signal switching unit 200 will determine not to perform the polarity exchange between the digital signals. That is to say, the digital signal switching unit 200 will still output the first digital data signal DS1 to the first data latch unit 221 of the first channel CH1 and output the second digital data signal DS2 to the second data latch unit 222 of the second channel CH2 without exchanging them.

Then, the first data latch unit 221 of the first channel CH1 transmits the first digital data signal DS1 to the P-type digital-to-analog converting unit 224, and the second data latch unit 222 of the second channel CH2 transmits the second digital data signal DS2 to the N-type digital-to-analog converting unit 225.

After the P-type digital-to-analog converting unit 224 receives the first digital data signal DS1, the P-type digital-to-analog converting unit 224 will convert the first digital data signal DS1 into a first analog data signal AS1 and output the first analog data signal AS1 to the analog signal switching unit 226.

Similarly, after the N-type digital-to-analog converting unit 225 receives the second digital data signal DS2, the N-type digital-to-analog converting unit 225 will convert the second digital data signal DS2 into a second analog data signal AS2 and output the second analog data signal AS2 to the analog signal switching unit 226.

After the analog signal switching unit 226 receives the first analog data signal AS1 and the second analog data signal AS2 from the P-type digital-to-analog converting unit 224 and the N-type digital-to-analog converting unit 225 respectively, since the digital signal switching unit 200 of the timing controller 20 does not perform the polarity exchange between the digital signals under the first operation mode, the analog signal switching unit 226 will determine not to switch according the polarity control signal POL, and still transmit the first analog data signal AS1 outputted from the first channel CH1 to the first amplifying unit 227 and transmit the second analog data signal AS2 outputted from the second channel CH2 to the second amplifying unit 228. Afterward, the first analog data signal AS1 and the second analog data signal AS2 will be amplified by the first amplifying unit 227 and the second amplifying unit 228 and outputted to the LCD panel (not shown in the figures).

Then, please refer to FIG. 4. FIG. 4 illustrates a functional block diagram of the driving circuit shown in FIG. 3 operated under a second operation mode.

As shown in FIG. 4, when the driving circuit 2 is operated under the second operation mode, the signal processing unit 204 of the timing controller 20 still transmits the first digital data signal DS1 and the second digital data signal DS2 to the digital signal switching unit 200, and the control unit 202 will also transmit the polarity control signal POL and the digital video signal converting signal STB to the digital signal switching unit 200.

It should be noticed that when the digital signal switching unit 200 receives the polarity control signal POL, the digital signal switching unit 200 will find out that the driving circuit 2 is operated under the second operation mode according to the polarity control signal POL; therefore, the digital signal switching unit 200 will determine to perform the polarity exchange between the digital signals. That is to say, the digital signal switching unit 200 will output the first digital data signal DS1 to the second data latch unit 222 of the second channel CH2 and output the second digital data signal DS2 to the first data latch unit 221 of the first channel CH1 to exchanging them.

Then, the first data latch unit 221 of the first channel CH1 will transmit the second digital data signal DS2 to the P-type digital-to-analog converting unit 224, and the second data latch unit 222 of the second channel CH2 will transmit the first digital data signal DS1 to the N-type digital-to-analog converting unit 225.

After the P-type digital-to-analog converting unit 224 receives the second digital data signal DS2, the P-type digital-to-analog converting unit 224 will convert the second digital data signal DS2 into a second analog data signal AS2 and output the second analog data signal AS2 to the analog signal switching unit 226.

Similarly, after the N-type digital-to-analog converting unit 225 receives the first digital data signal DS1, the N-type digital-to-analog converting unit 225 will convert the first digital data signal DS1 into a first analog data signal AS1 and output the first analog data signal AS1 to the analog signal switching unit 226.

After the analog signal switching unit 226 receives the second analog data signal AS2 and the first analog data signal AS1 from the P-type digital-to-analog converting unit 224 and the N-type digital-to-analog converting unit 225 respectively, since the digital signal switching unit 200 of the timing controller 20 performs the polarity exchange between the digital signals under the second operation mode, the analog signal switching unit 226 will determine to switch according the polarity control signal POL, and transmit the second analog data signal AS2 outputted from the first channel CH1 to the second amplifying unit 228 and transmit the first analog data signal AS1 outputted from the second channel CH2 to the first amplifying unit 227. Afterward, the first analog data signal AS1 and the second analog data signal AS2 will be amplified by the first amplifying unit 227 and the second amplifying unit 228 and outputted to the LCD panel (not shown in the figures).

As shown in FIG. 3 and FIG. 4, a lot of first multiplex switching units 123 corresponding to every two channels in the source driver 12 of FIG. 2 for polarity exchange between the digital data signals is not necessary for the source driver 22 of the invention, therefore, the production cost can be effectively lowered and the chip area used by the driving circuit can be largely saved.

Another embodiment of the invention is a driving circuit operating method. In this embodiment, the driving circuit operating method is applied in a driving circuit of a LCD apparatus, but not limited to this. The driving circuit has two operation modes. The driving circuit includes at least one first channel, at least one second channel, a timing controller, and a panel driver. The timing controller includes a digital signal switching unit. The panel driver includes an analog signal switching unit. Please refer to FIG. 5. FIG. 5 illustrates a flowchart of the driving circuit operating method in this embodiment.

As shown in FIG. 5, in step S10, the digital signal switching unit of the timing controller selectively performs a polarity exchange to a first digital data signal and a second digital data signal according to a control signal. In step S12, the analog signal switching unit performs a switching corresponding to the polarity exchange according to the control signal. In step S14, the driving circuit is selectively operated under a first operation mode or a second operation mode.

Next, the first operation mode and the second operation mode of the above-mentioned driving circuit will be further introduced respectively.

At first, please refer to FIG. 6. FIG. 6 illustrates a flowchart of the driving circuit operating method when the driving circuit is operated under the first operation mode. As shown in FIG. 6, in step S20, the driving circuit is operated under the first operation mode. In step S22, the digital signal switching unit will output the first digital data signal DS1 to the first channel CH1 and output the second digital data signal DS2 to the second channel CH2. In step S24, the first digital-to-analog converting unit will convert the first digital data signal DS1 into a first analog data signal AS1 and output the first analog data signal AS1 to the analog signal switching unit, and the second digital-to-analog converting unit will convert the second digital data signal DS2 into a second analog data signal AS2 and output the second analog data signal AS2 to the analog signal switching unit. In step S26, the analog signal switching unit will output the first analog data signal AS1 to the first amplifying unit and output the second analog data signal AS2 to the second amplifying unit.

In practical applications, after the first analog data signal AS1 and the second analog data signal AS2 are amplified by the first amplifying unit and the second amplifying unit respectively, the first amplifying unit and the second amplifying unit will output the amplified first analog data signal AS1 and second analog data signal AS2 to the LCD panel respectively.

Then, please refer to FIG. 7. FIG. 7 illustrates a flowchart of the driving circuit operating method when the driving circuit is operated under the first operation mode. As shown in FIG. 7, in step S30, the driving circuit is operated under the second operation mode. In step S32, the digital signal switching unit will output the first digital data signal DS1 to the second channel CH2 and output the second digital data signal DS2 to the first channel CH1. In step S34, the first digital-to-analog converting unit will convert the second digital data signal DS2 into a second analog data signal AS2 and output the second analog data signal AS2 to the analog signal switching unit, and the second digital-to-analog converting unit will convert the first digital data signal DS1 into a first analog data signal AS1 and output the first analog data signal AS1 to the analog signal switching unit. In step S36, the analog signal switching unit will exchange the first analog data signal AS1 and the second analog data signal AS2 to output the first analog data signal AS1 to the first amplifying unit and output the second analog data signal AS2 to the second amplifying unit.

In practical applications, after the first analog data signal AS1 and the second analog data signal AS2 are amplified by the first amplifying unit and the second amplifying unit respectively, the first amplifying unit and the second amplifying unit will output the amplified first analog data signal AS1 and second analog data signal AS2 to the LCD panel respectively.

As to the detail of the driving circuit practical operation, since it is introduced in the above-mentioned embodiments, it is not described again here.

Compared to the prior arts, the driving circuit and operating method thereof disclosed by this invention uses the digital signal switching unit in the timing controller to selectively perform polarity exchange between the digital data signals according to the polarity control signal (POL), and then inputs these digital data signal into the source driver. By doing so, the source driver performs no digital data signal polarity exchange as shown in FIG. 2A, therefore, the first multiplex switching units 123 disposed corresponding to every two channels are not necessary to effectively lower production cost and largely save the chip area used by the driving circuit to enhance the market competitiveness of the driving circuit and the LCD apparatus using the driving circuit disclosed by this invention.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A driving circuit, applied in a LCD apparatus, the driving circuit comprising:
at least one first channel;
at least one second channel;
a timing controller, comprising a digital signal switching unit coupled to input ends of the at least one first channel and the at least one second channel, the digital signal switching unit selectively performing a polarity exchange to a first digital data signal and a second digital data signal according to a control signal; and
a panel driver, comprising an analog signal switching unit coupled to output ends of the at least one first channel and the at least one second channel, the analog signal switching unit performing a switching corresponding to the polarity exchange according to the control signal to make the driving circuit selectively operated under a first operation mode or a second operation mode.

2. The driving circuit of claim 1, wherein when the driving circuit is operated under the first operation mode, the digital signal switching unit inputs the first digital data signal to the first channel and inputs the second digital data signal to the second channel according to the control signal; when the driving circuit is operated under the second operation mode, the digital signal switching unit inputs the first digital data signal to the second channel and inputs the second digital data signal to the first channel according to the control signal.

3. The driving circuit of claim 2, wherein the panel driver further comprises:
a first digital-to-analog converting unit, coupled to the analog signal switching unit; and
a second digital-to-analog converting unit, coupled to the analog signal switching unit.

4. The driving circuit of claim 3, wherein when the driving circuit is operated under the first operation mode, the first digital-to-analog converting unit converts the first digital data signal into a first analog data signal, and the second digital-to-analog converting unit converts the second digital data signal into a second analog data signal.

5. The driving circuit of claim 4, wherein the analog signal switching unit receives the first analog data signal from the first digital-to-analog converting unit and receives the second analog data signal from the second digital-to-analog converting unit, the analog signal switching unit performs no switch according to the control signal and directly outputs the first analog data signal and the second analog data signal respectively.

6. The driving circuit of claim 3, wherein when the driving circuit is operated under the second operation mode, the first digital-to-analog converting unit converts the second digital data signal into a second analog data signal, and the second digital-to-analog converting unit converts the first digital data signal into a first analog data signal.

7. The driving circuit of claim 6, wherein the analog signal switching unit receives the second analog data signal from the first digital-to-analog converting unit and receives the first analog data signal from the second digital-to-analog converting unit, the analog signal switching unit switches the first analog data signal and the second analog data signal according to the control signal and then outputs the switched first analog data signal and second analog data signal.

8. The driving circuit of claim 1, wherein the digital signal switching unit and the analog signal switching unit are multiplexers.

9. The driving circuit of claim 1, wherein the panel driver is a source driver of a panel.

10. The driving circuit of claim 1, wherein the control signal is a polarity control signal.

11. A driving circuit operating method, applied in a driving circuit of a LCD apparatus, the driving circuit comprising at least one first channel, at least one second channel, a timing controller, and a panel driver, the timing controller comprising a digital signal switching unit, and the panel driver comprising an analog signal switching unit, the driving circuit operating method comprising steps of:
the digital signal switching unit selectively performing a polarity exchange to a first digital data signal and a second digital data signal according to a control signal;
the analog signal switching unit performing a switching corresponding to the polarity exchange according to the control signal; and
the driving circuit being selectively operated under a first operation mode or a second operation mode.
